(19) United States
(12) Patent Application Publication
(10) Pub. No.: US 2005/0005989 A1
(43) Pub. Date: Jan. 13, 2005

(54) Cross-linked thermoplastic tubing

(76) Inventor: Dietmar Roloff, Bielefeld (DE)

Correspondence Address: CARLSON, GASKEY & OLDS, P.C., 400 WEST MAPLE ROAD, SUITE 350, BIRMINGHAM, MI, 48009, US

(21) Appl. No.: 10/799,343

(22) Filed: Mar. 12, 2004

(30) Foreign Application Priority Data
Mar. 15, 2003 (DE) 103 11 500.5

(51) Int. Cl. F16L 11/00

(52) U.S. Cl. 138/137; 428/36.91

(57) ABSTRACT

A tubing includes a layer of cross-linked polyamide. The polyamide layer can include a cross-linking aid, such as triallyliscocyanurant or TAIC, to assist in cross-linking the layer. When the polyamide layer is exposed to high-level radiation, the polyamide layer cross-links to provide a layer having high temperature resistance and high glycol resistance. In another embodiment, the tubing includes a first layer of a cross-linked thermoplastic and a second layer to form a multi-layer tubing. The thermoplastic of the first layer can be polyamide, aromatic nylon, polyolefins, polyvinyl chloride or polyester.

The patent application claims priority to German Patent Application DE 103 11 500.5 filed on Mar. 15, 2003.

### BACKROUND OF THE INVENTION

The invention relates generally to a tubing having at least one layer of cross-linked thermoplastic.

A known tubing disclosed in German Patent Application DE 195 35 489 C1 has three layers. The tubing has an inner layer of polyvinylidine fluoride (PVDF), an outer layer of polyamide (PA), preferably polyamide 11 or polyamide 12, and a middle layer that adheres the inner layer and the outer layer. This known type of tubing is commonly used as a cooling water tubing in engine coolant systems. It is important that the outer polyamide layer have both high temperature resistance and high glycol resistance.

The technical properties of polyethylene (PE) tubes can be improved by cross-linking. For example, cross-linking provides polyethylene with high temperature and chemical resistance. Polyethylene tubes are commonly used as underfloor heating pipes. When cross-linked, polyethylene loses its thermoplastic character and can be used in higher service temperatures. The cross-linking can either be a chemical process or a physical process. In a chemical cross-linking process, peroxides decay into radicals at certain temperatures (120°-130° C.) to cross-link the polyethylene. In a physical cross-linking process, high level radiation, such as electron beams, proton beams, gamma rays or x-rays, cross-links the polyethylene.

Rubber hoses provide temperature and chemical resistance. However, there are several drawbacks to employing rubber hoses. For one, a reinforcement, such as a braided or spiral fiber embedded in the wall of the hose, is needed for strength. Additionally, a curing or fixing process is needed after extrusion to maintain the elastic properties of the tubing, requiring additional labor and expense.

It would be beneficial to provide a tubing including a layer of cross-linked polyamide that provides increased temperature and chemical resistance.

### SUMMARY OF THE INVENTION

The tubing of the present invention includes at least one layer of a thermoplastic cross-linked by high-level radiation. In a first embodiment, the tubing includes a layer of cross-linked polyamide. In one example, the tubing includes an inner layer of a fluoropolymer, a middle adhesive layer essentially made of a fluoropolymer, and an outer layer of cross-linked polyamide. The polyamide layer can include a cross-linking aid to assist the polyamide in cross-linking when exposed to high-level radiation. In one example, the cross-linking aid is triallyliscocyanurant or TAIC. The other layers can include an additive to prevent these layers from cross-linking when exposed to high-level radiation.

A pre-form is inserted into the tubing during production. The tubing is then thermoformed to retain the tubing in the desired form. A fitting or connection armature is inserted into the opposing ends of the tubing to allow the tubing to be easily fitted to the appropriate parts. After thermoforming, the tubing is exposed to high-level radiation to cross-link the polyamide layer.

In another embodiment, the tubing is a multi-layer tubing including a first layer of a cross-linked thermoplastic and a second thermoplastic layer. A third adhesive layer can be employed to adhere the first cross-linked thermoplastic layer to the second layer. For example, the thermoplastic of the first layer can be polyamide, aromatic nylon, polyolefins, polyvinyl chloride or polyester.

These and other features of the present invention will be best understood from the following specification and drawings.

### BRIEF DESCRIPTION OF THE DRAWINGS

The various features and advantages of the invention will become apparent to those skilled in the art from the following detailed description of the currently preferred embodiment. The drawings that accompany the detailed description can be briefly described as follows:

FIG. 1 schematically illustrates a cross-sectional longitudinal view of a first embodiment of the tubing of the present invention including three layers;

FIG. 2 schematically illustrates a cross-sectional view of the tubing taken along line II-II of FIG. 1;

FIG. 3 schematically illustrates the process of forming the tubing of the present invention;

FIG. 4 schematically illustrates a cross-sectional view of a second embodiment of the tubing of the present invention including one layer of cross-linked polyamide;

FIG. 5 schematically illustrates a third embodiment of the tubing of the present invention including a cross-linked layer of polyamide or polyethylene over a steel tube; and

FIG. 6 schematically illustrates a fourth embodiment of the tubing of the present invention including a cross-linked thermoplastic layer as part of a multi-layer tubing.

### DETAILED DESCRIPTION OF THE PREFERRED EMBODIMENT

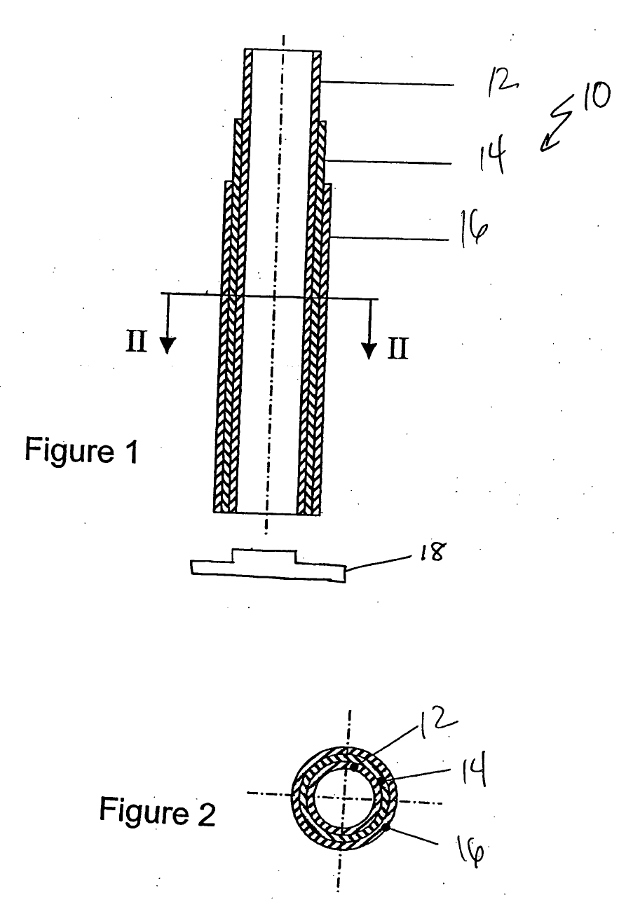

FIG. 1 schematically illustrates a longitudinal view of the tubing 10 of the present invention. The tubing 10 includes an inner layer 12 of a fluoropolymer, a middle adhesive layer 14 with at least the essential part being made of a fluoropolymer, and an outer layer of cross-linked polyamide 16. The fluoropolymer of the inner layer 12 can be polyvinylidine fluoride or any other suitable fluoropolymer. The outer layer 16 can be polyamide 11, polyamide 12, polyamide 6, polyamide 4,6, polyamide 6,6 or any other polyamide. Preferably, the middle adhesive layer 14 is a modified polyvinylidine fluoride including polyamide. The length of the layers 12, 14 and 16 illustrated in FIG. 1 are not drawn to scale and are shown as having different lengths for illustrative clarity only. Although the layers 12 and 14 have been illustrated and described, it is to be understood that additional layers can be employed.

FIG. 2 illustrates a cross-sectional view of the tubing 10 of the present invention. The inner layer 12 preferably has a thickness between 0.1 to 0.3 mm. The middle layer 14 preferably has a thickness between 0.05 to 0.15 mm. The outer layer 16 preferably has a thickness between 0.7 to 1.7 mm.

In one example, the tubing 10 is a cooling water tube. However, the tubing 10 can also be a fuel line, an engine coolant line, a vacuum line, a transmission oil cooling line, or in a heater line. It is to be understood that other uses of the tubing 10 can be employed, and one skilled in the art would understand how to utilize the tubing 10.

The tubing 10 is exposed to high-level radiation to cross-link the polyamide layer 16. The high-level radiation can be provided by electron beams, proton beams, gamma rays or x-rays. One skilled in the art would know what types of high-level radiation to employ to cross-link the polyamide. For example, the amount of radiation can be above 1 kilogray of radiation. By cross-linking the polyamide layer 16, the temperature resistance and the chemical resistance of the polyamide layer 16 increases.

When the high-level radiation hits the polyamide layer 16, free radicals are formed. The free radicals attack the amide groups of the polyamide, causing the polyamide to be reactive and then cross-link. By cross-linking the polyamide layer 16, the tubing 10 has an increased temperature resistance and chemical resistance. For example, chemical resistance can make the tubing glycol resistant. The tubing 10 can be exposed to the high-level radiation at once as a load or exposed to the high-level radiation through multiples passes in a cycle.

Alternately, the polyamide layer 16 includes a cross-linking aid to further increase cross-linking of the polyamide. In one example, the cross-linking aid is triallyliscocyanurant or TAIC. Other cross-linking aids include triallylcyanurate (TAC), trimethylolpropane trimethylacrylate (TNPTMA), triallyl trimellitate (TATM), N,N′-m-phenylenediamaleimide (HVA-2) and diallyl phthalate (DAP). However, it is to be understood that any suitable cross-linking aid can be employed. Preferably, the cross-linking aid is blended with the polyamide and added in an amount less than 5% by weight. The cross-linking can occur between polyamides or between polyamide and the cross-linking aid.

An additive can be added to the inner layer 12 and the middle layer 14 to prevent cross-linking or degradation of the thermoplastics in the layers 12 and 14 when exposed to high-level irradiation. In one example, the additive is an anti-oxidant or inhibitor. However, it is to be understood that other additives can be employed to prevent cross-linking.

A fitting 18 or a connection armature is positioned at the opposing ends of the tubing 10 (FIG. 1). The fittings 18 allow the tubing 10 to be easily fitted to the appropriate parts. In one example, the fittings 18 are made of polyamide and includes a cross-linking aid to assist the polyamide in cross-linking when exposed to high level radiation.

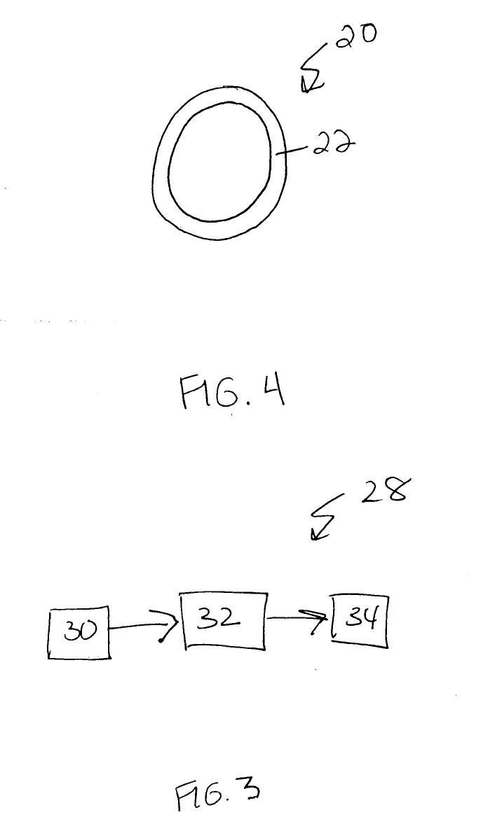

FIG. 3 schematically illustrates the process 28 of forming the tubing 10 of the present invention. During production, a pre-form is inserted 30 into the tubing 10 to retain the shape of the tubing 10. The tubing 10 is then inserted in a device to thermoform 32 the tubing 10 into the desired shape. After thermoforming 32, the tubing 10 retains the shape set by the thermoforming process 32. The tubing 10 is then exposed to the high-level radiation 34 after thermoforming 32. Although a pre-form is described as being inserted into the tubing 10, it is to be understood that the tubing 10 can be formed without a pre-form. Additionally, it is also possible for the tubing 10 to be first exposed to radiation and then formed.

The tubing 10 can also be convoluted or corrugated to provide flexibility. The convolutions are generally formed before the polyamide layer 16 is cross-linked. However, it is possible that the convolutions can be formed after cross-linking.

FIG. 4 schematically illustrates a second embodiment of the tubing 20 of the present invention. In this embodiment, the tubing 20 includes only a single layer of cross-linked polyamide 22. The single layer of the tubing 20 can be polyamide 11, polyamide 12, polyamide 6, polyamide 4,6, polyamide 6,6 or any other polyamide. The tubing 20 can also include a cross-linking aid as described above. Additionally, the tubing 20 can be corrugated.

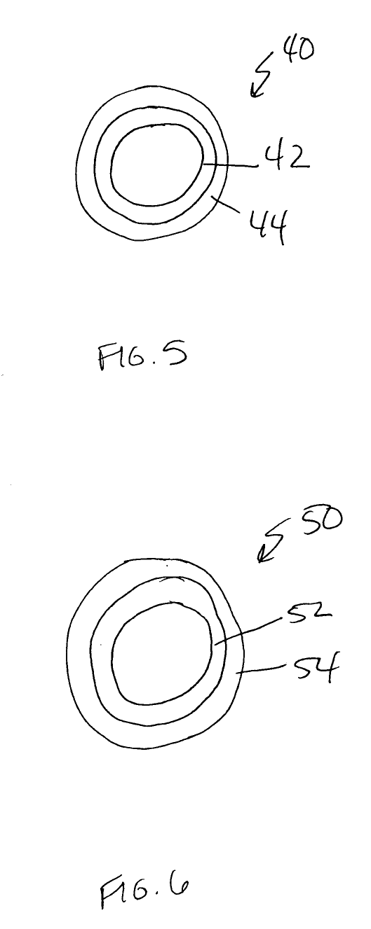

FIG. 5 schematically illustrates a third embodiment of the tubing 40 of the present invention. The tubing 40 includes a cross-linked polyamide layer or a cross-linked polyolefin layer 44 applied over a steel tube 42. In one example, the polyolefin is polyethylene. The cross-linked polyamide layer or the cross-linked polyolefin layer 44 can be applied via extrusion, injection molding, powder coating, painting or other applications processes prior to cross-linking. The polyamide layer or polyolefin layer 44 is cross-linked by exposure to high-level radiation. However, it is to be understood that other cross-linked thermoplastics can be layered over the steel tube 42.

FIG. 6 schematically illustrates a fourth embodiment of the tubing 50 of the present invention. The tubing 50 includes a first layer 54 of a cross-linked thermoplastic and a second layer 52 of a thermoplastic. The first layer 54 can be polyamide, aromatic nylon, polyolefin (such as polyethylene or polypropylene), polyvinyl chloride or polyester. Examples of polyamides are polyamide 11, polyamide 12, polyamide 6, polyamide 4,6, polyamide 6,6 or any other polyamide. When exposed to high-level radiation, the first layer 54 cross-links to provide increased chemical and temperature resistance. Although the first layer of cross-linked thermoplastic 54 is illustrated as the outer layer, it is to be understood that the layer of cross-linked thermoplastic 54 can be any layer in the tubing 50. It is also to be understood that other layers can be employed in addition to the first layer 54 and the second layer 52. For example, an adhesive layer (not shown) can be utilized between the first layer 54 and the second layer 52 to adhere the layers 52, 54. Additionally, it is possible that the first layer 54 can include a cross-linking aid to promote cross-linking, and the second layer 52 can include an anti-oxidant or inhibitor to prevent cross-linking.

The foregoing description is only exemplary of the principles of the invention. Many modifications and variations of the present invention are possible in light of the above teachings. The preferred embodiments of this invention have been disclosed, however, so that one of ordinary skill in the art would recognize that certain modifications would come within the scope of this invention. It is, therefore, to be understood that within the scope of the appended claims, the invention may be practiced otherwise than as specifically described. For that reason the following claims should be studied to determine the true scope and content of this invention.

1. A tubing comprising a cross-linked polyamide layer defining a fluid conduit.

2. The tubing as recited in claim 1 wherein the polyamide layer is cross-linked by exposure to high-level radiation.

3. The tubing as recited in claim 1 wherein the polyamide layer further includes a cross-linking aid.

4. The tubing as recited in claim 3 wherein said cross-linking aid is triallyliscocyanurant.

5. The tubing as recited in claim 3 wherein said cross-linking aid is one of triallylcyanurate, trimethylolpropane trimethylacrylate, triallyl trimellitate, N,N′-m-phenylenediamaleimide and diallyl phthalate.

6. The tubing as recited in claim 1 wherein the polyamide layer is one of polyamide 11 and polyamide 12.

7. The tubing as recited in claim 1 further including an inner layer of a polyvinylidine fluoride, a middle layer of an adhesive, and the polyamide layer is an outer layer.

8. The tubing as recited in claim 7 wherein the middle layer is a modified polyvinylidine fluoride.

9. The tubing as recited in claim 7 wherein the polyamide layer has a thickness between 0.7 mm and 1.7 mm.

10. The tubing as recited in claim 7 wherein the inner layer has a thickness between 0.1 mm and 0.3 mm.

11. The tubing as recited in claim 7 wherein the middle layer has a thickness between 0.05 mm and 0.15 mm.

12. The tubing as recited in claim 1 wherein the tubing is a flexible water cooling tube.

13. The tubing as recited in claim 7 wherein at least one of the inner layer and the middle layer include one of an anti-oxidant and an inhibitor.

14. The tubing as recited in claim 13 wherein the one of the anti-oxidant and the inhibitor prevents cross-linking of at least one of the inner layer and the middle layer.

15. A method of forming a tubing comprising the steps of:
a) providing a layer of polyamide; and
b) exposing the layer of polyamide to radiation to cross-link the polyamide layer.

16. The method as recited in claim 15 wherein said step b includes exposing the layer of polyamide to high-level radiation.

17. The method as recited in claim 16 wherein said step b includes exposing the layer of polyamide to high-level radiation in cycles.

18. The method as recited in claim 16 wherein said step b includes exposing the layer of polyamide to high-level radiation in loads.

19. The method as recited in claim 16 wherein said step b includes employing one of electron beams, proton beams, gamma rays and x-rays.

20. The method as recited in claim 15 further including the step of thermoforming the layer of polyamide, and said step of thermoforming occurs before the step of exposing the layer of polyamide to radiation.

21. The method as recited in claim 15 further including the step of thermoforming the layer of polyamide, and said step of thermoforming occurs after the step of exposing the layer of polyamide to radiation.

22. The method as recited in claim 15 further including the step of mixing a cross-linking aid with polyamide to provide the layer of polyamide.

23. The method as recited in claim 22 wherein the cross-linking aid is triallyliscocyanurant.

24. A tubing comprising:
a first cross-linked layer of a thermoplastic selected from the group consisting of polyamide, aromatic nylon, polyolefin, polyvinyl chloride and polyester; and
a second layer of a thermoplastic.

25. The tubing as recited in claim 24 further including an adhesion layer that adheres the first layer to the second layer.

26. The tubing as recited in claim 24 wherein the first cross-linked layer of a thermoplastic further includes a cross-linking aid.

27. The tubing as recited in claim 26 wherein the cross-linking aid is triallyliscocyanurant.

28. The tubing as recited in claim 24 wherein the first cross-linked layer is cross-linked by exposure to high-level radiation.

29. The tubing as recited in claim 24 wherein the second layer includes one of an anti-oxidant and an inhibitor.

30. The tubing as recited in claim 29 wherein the one of the anti-oxidant and the inhibitor prevents cross-linking of the second layer.
